(19) United States
(12) Patent Application Publication
(10) Pub. No.: US 2021/0097422 A1
(43) Pub. Date: Apr. 1, 2021

(54) GENERATING MIXED STATES AND FINITE-TEMPERATURE EQUILIBRIUM STATES OF QUANTUM SYSTEMS

(71) Applicant: X Development LLC, Mountain View, CA (US)

(72) Inventor: Guillaume Verdon-Akzam, Waterloo (CA)

(21) Appl. No.: 17/035,333

(22) Filed: Sep. 28, 2020

Related U.S. Application Data
(60) Provisional application No. 62/907,440, filed on Sep. 27, 2019.

(51) Int. Cl. G06N 10/00; G06F 15/16

(52) U.S. Cl. CPC G06N 10/00; G06F 15/16

(57) ABSTRACT

Methods, systems, and apparatus for preparing a target mixed state of a quantum system. In some aspects a method includes preparing a parameterized ansatz quantum state as an initial approximation to the target mixed state, wherein the parameterized ansatz quantum state comprises a first set of variational parameters and a second set of variational parameters; determining, by classical and quantum computation, values of the first set of variational parameters and second set of variational parameters that minimize a quantum relative entropy of the target mixed state with respect to the parameterized ansatz quantum state; and preparing the parameterized ansatz quantum state with the determined values of the first set of variational parameters and second set of variational parameters as a final approximation to the target mixed state.

### CROSS-REFERENCE TO RELATED APPLICATION

This application claims priority under 35 U.S.C. 119 to Provisional Application No. 62/907,440, filed Sep. 27, 2019, which is incorporated by reference.

### BACKGROUND

This specification relates to quantum computing.

The quantum theory of pure quantum states describes states of null Von Neumann entropy and, equivalently, of unit purity. Such quantum states can arise in nature as ground states of quantum systems, e.g., equilibrium states of quantum systems at absolute zero temperature. Another scenario where pure quantum states are encountered is in idealized situations describing quantum computations or quantum coherent evolution of certain quantum systems. However, the assumption that the quantum system is closed, e.g., isolated from it environment, is often an idealized unrealistic assumption.

Most quantum states in nature are rather mixed states, since most quantum systems are open quantum systems and exposure to the environment yields a classical-probabilistic mixture of quantum states. Furthermore, most physical systems operate at finite non-zero temperature. Therefore, for the purposes of quantum simulation, thermal states are very important to simulate.

Most current methods for quantum machine learning and variational quantum circuits learn to generate only pure states. For example, variational quantum un-sampling techniques learn pure states and the Variational Quantum Eigensolver generate approximations to ground states/pure eigenstates. In addition, current methods that provide a form of mixed quantum state learning employ the Hilbert-Schmidt distance as a metric. This metric is not adequate for high-rank (e.g., high entropy) quantum states.

### SUMMARY

This specification describes technologies for generating target quantum states of quantum systems. In particular, methods and systems for the generative tasks of preparing a thermal state of a quantum system and learning an approximate reconstruction of a mixed state of a quantum system.

In general, one innovative aspect of the subject matter described in this specification can be implemented in a method for preparing a target mixed state of a quantum system, the method comprising: preparing a parameterized ansatz quantum state as an initial approximation to the target mixed state, wherein the parameterized ansatz quantum state comprises a first set of variational parameters and a second set of variational parameters; determining, by classical and quantum computation, values of the first set of variational parameters and second set of variational parameters that minimize a quantum relative entropy of the target mixed state with respect to the parameterized ansatz quantum state; and preparing the parameterized ansatz quantum state with the determined values of the first set of variational parameters and second set of variational parameters as a final approximation to the target mixed state.

Other implementations of this aspect include corresponding classical and quantum computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations preparing the parameterized ansatz quantum state comprises applying a unitary operator to a latent quantum state, wherein the unitary operator comprises the first set of variational parameters and the latent quantum state comprises the second set of variational parameters.

In some implementations the latent quantum state is based on a parametric set of probability distributions, for example an exponential family.

In some implementations the parametric set of probability distributions are classically sampled.

In some implementations the latent quantum state comprises a parametrized latent separated mixed state.

In some implementations the latent quantum state comprises a diagonal quantum state, wherein diagonal elements of the diagonal quantum state comprise sampled values of a parametric set of probability distributions.

In some implementations determining values of the first set of variational parameters and second set of variational parameters that minimize a quantum relative entropy of the target mixed state with respect to the parameterized ansatz quantum state comprises determining values of the first set of variational parameters and second set of variational parameters that minimize a loss function based on the quantum relative entropy of the target mixed state with respect to the parameterized ansatz quantum state, wherein the loss function is given by

[symbol]

_{θφ}=tr( [symbol] \hat{K}_{θφ})+log Z_{θ}

where [symbol] represents the target mixed state, \hat{K}_{θφ} represents a target Hamiltonian that is based on the first set of variational parameters and second set of variational parameters, and Z_{θ}=tr(e^{-\hat{K}}^{_{θ}}) represents a partition function with \hat{K}_{θ} representing a latent modular Hamiltonian.

In some implementations determining, by classical and quantum computation, values of the first set of variational parameters and second set of variational parameters that minimize a quantum relative entropy of the target mixed state with respect to the parameterized ansatz quantum state comprises: setting initial values of the first set of variational parameters and the second set of variational parameters; and iteratively determining a gradient of the loss function with respect to the first set of variational parameters and the second set of variational parameters until convergence criteria are met.

In some implementations determining a gradient of the loss function with respect to the first set of variational parameters and the second set of variational parameters comprises determining a partial derivative of the loss function with respect to the first set of variational parameters and the second set of variational parameters.

In some implementations determining the partial derivative of the loss function with respect to the second set of variational parameters comprises computing the gradient of an energy expectation of a latent modular Hamiltonian with respect to a first pulled back data state, wherein the first pulled back data state is generated by applying a quantum circuit to the target mixed state, the quantum circuit representing an inverse of a unitary operator used to prepare the parameterized ansatz quantum state.

In some implementations computing the gradient comprises computing the gradient according to a finite difference method or parameter shift gradient estimator.

In some implementations determining the partial derivative of the loss function with respect to the first set of variational parameters comprises determining a difference between i) an expected value of the gradient of an energy function with respect to a first pulled back data state, wherein the first pulled back data state is generated by applying a quantum circuit to the target mixed state, the quantum circuit representing an inverse of a unitary operator used to prepare the parameterized ansatz quantum state, and ii) an expected value of the gradient of a distribution that can be classically sampled.

In some implementations determining the partial derivative of the loss function with respect to the first set of variational parameters is independent of the partition function Z₉.

In some implementations iteratively determining a gradient of the loss function with respect to the first set of variational parameters and the second set of variational parameters until convergence criteria are met comprises, upon convergence, combining the determined partial derivatives.

In some implementations the target mixed state comprises a quantum state stored as quantum data in quantum memory.

In general, another innovative aspect of the subject matter described in this specification can be implemented in a method for preparing a thermal state of a quantum system, the method comprising: preparing a parameterized ansatz quantum state as an initial approximation to the target thermal state, wherein the parameterized ansatz quantum state comprises a first set of variational parameters and a second set of variational parameters; determining, by classical and quantum computation, values of the first set of variational parameters and second set of variational parameters that minimize a quantum relative entropy of the parameterized ansatz quantum state with respect to the target thermal state; and preparing the parameterized ansatz quantum state with the determined values of the first set of variational parameters and second set of variational parameters as a final approximation to the target thermal state.

Other implementations of this aspect include corresponding classical and quantum computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations preparing the parameterized ansatz quantum state comprises applying a unitary operation to a latent quantum state, wherein the unitary operation comprises the first set of variational parameters and the latent quantum state comprises the second set of variational parameters.

In some implementations the latent quantum state is based on a parametric set of probability distributions, for example an exponential family.

In some implementations the parametric set of probability distributions are classically sampled.

In some implementations the latent quantum state comprises a parametrized latent separated mixed state.

In some implementations the latent quantum state comprises a diagonal quantum state, wherein diagonal elements of the diagonal quantum state comprise sampled values of the parametric set of probability distributions.

In some implementations the target thermal state is defined by a target Hamiltonian and a target temperature.

In some implementations determining, by classical and quantum computation, values of the first set of variational parameters and second set of variational parameters that minimize a quantum relative entropy of the parameterized ansatz quantum state with respect to the target thermal state comprises: computing, for varying values of the first set of variational parameters, multiple expectation values of the target Hamiltonian with respect to the parameterized ansatz quantum state; and computing, for varying values of the second set of variational parameters, multiple expectation values of the target Hamiltonian with respect to the parameterized ansatz quantum state.

In some implementations determining values of the first set of variational parameters and second set of variational parameters that minimize a quantum relative entropy of the parameterized ansatz quantum state with respect to the target thermal state comprises determining values of the first set of variational parameters and second set of variational parameters that minimize a loss function based on the quantum relative entropy of the parameterized ansatz quantum state with respect to the target thermal state, wherein the loss function is given by

[symbol]

_{θφ} =βtr(ρ_{θφ}H)−S(\hat{ρ}_{θφ})

where \hat{ρ}_{θφ} represents the parameterized ansatz quantum state, H represents a target Hamiltonian that defines the target thermal state, and β represents a target temperature that defines the target thermal state.

In some implementations determining, by classical and quantum computation, values of the first set of variational parameters and second set of variational parameters that minimize a quantum relative entropy of the parameterized ansatz quantum state with respect to the target thermal state comprises: setting initial values of the first set of variational parameters and the second set of variational parameters; and iteratively determining a gradient of the loss function with respect to the first set of variational parameters and the second set of variational parameters until convergence criteria are met.

In some implementations determining a gradient of the loss function with respect to the first set of variational parameters and the second set of variational parameters comprises determining a partial derivative of the loss function with respect to the first set of variational parameters and the second set of variational parameters.

In some implementations determining the partial derivative of the loss function with respect to the first set of variational parameters comprises computing a set of expectation values that are dependent on a classical energy function, a pushed forward Hamiltonian and a gradient of the classical energy function, wherein the pushed forward Hamiltonian is generated by applying a quantum circuit to the target Hamiltonian, the quantum circuit representing an inverse of a unitary operator used to prepare the parameterized ansatz quantum state.

In some implementations determining the partial derivative of the loss function with respect to the first set of variational parameters is independent of an entropy or partition function.

In some implementations determining the partial derivative of the loss function with respect to the second set of variational parameters comprises computing a gradient of an expectation value of a quantum state with respect to the target Hamiltonian, wherein the quantum state is generated by applying a quantum circuit to the latent quantum state, the quantum circuit representing a unitary operator used to prepare the parameterized ansatz quantum state.

In some implementations computing the gradient comprises computing the gradient according to a finite difference method or parameter shift gradient estimator.

In some implementations iteratively determining a gradient of the loss function with respect to the first set of variational parameters and the second set of variational parameters until convergence criteria are met comprises, upon convergence, combining the determined partial derivatives.

In some implementation the method further comprises determining a thermodynamic free energy of the quantum system based on determining the values of the first set of variational parameters and second set of variational parameters that minimize a quantum relative entropy of the parameterized ansatz quantum state with respect to the target thermal state.

The subject matter described in this specification can be implemented in particular ways so as to realize one or more of the following advantages.

The techniques described in this specification enable mixed quantum states and thermal quantum states to be learned and reproduced with high fidelity. Unlike known techniques for learning mixed quantum states that are typically tailored specifically for low-rank density matrices, the presently described techniques are generic and can be applied to mixed and thermal states of any rank. In addition, the presently described techniques enable estimates of mixed state entropy, free energy, and the diagonalizing transformation of the target system, the last of which enables modular time evolution and facilitates full quantum simulation of a previously unknown system. This provides the possibility of using quantum machine learning to compute state entropies of analytically intractable systems.

Another advantage over previously proposed variational quantum algorithms for quantum state diagonalization is that the presently described techniques employ relative entropy rather than a Hilbert-Schmidt metric, thus enabling the diagonalization of much higher rank quantum states. Furthermore, learning to diagonalize a quantum density matrix is related to the Quantum Principal Component Analysis algorithm for classical data, and other related quantum machine learning algorithms. The presently described techniques provide a variational alternative method for these algorithms, circumventing the need for long quantum circuits for quantum state exponentiation, which has been deemed intractable even for far-term quantum computers when compiled. Although the requirement of state preparation is not removed, the presently described techniques do not require complex components and have the potential to demonstrate a quantum advantage for learning the unitary which diagonalizes either a quantum Hamiltonian or quantum density matrix.

The presently described techniques present several key advantages relative to other forms of unsupervised quantum learning with quantum neural networks such as quantum Generative Adversarial Networks (GANs). GANs (both quantum and classical) are notoriously difficult to train, and once trained, difficult to extract physical quantities from. The presently described techniques represent physical quantities more directly, and as such are much more suitable for applications that involve physical quantum data. The presently described techniques also train very robustly and with few iterations. Furthermore, the presently described techniques require less quantum circuit depth during training than quantum GANs, which require both a quantum generator and quantum discriminator. The latter is a key consideration for possible implementation on near-term intermediate scale quantum devices.

In addition, in the presently described techniques, it is not that only a distribution for the modular Hamiltonian and thermal state, respectively, are learned. Rather, efficient approximate parameterizations of these quantities are learned. In the context of VQT, this provides the ability to directly prepare a thermal state on a quantum computer using polynomial resources, from knowledge of a corresponding Hamiltonian. For Modular Hamiltonian Learning, once an efficient ansatz has learned the optimal value of parameters such that its output approximates a data mixed state, this provides the ability to reproduce as many copies of the learned mixed state distributions as desired. In addition, the modular Hamiltonian itself provides invaluable information related to topological properties, thermalization, and non-equilibrium dynamics.

In addition, Modular Hamiltonian Learning gives access to the eigenvalues of the density matrix and the unitary that diagonalizes the Modular Hamiltonian. Applying the QNN to a quantum state brings it into the eigenbasis of the Modular Hamiltonian. In this basis, an exponentiation of the diagonal latent modular Hamiltonian (which a classical description of is known) implements modular time evolution. The inverse of the QNN can be applied to return to the original computational basis. In the same vein, QMHL provides the ability to probe a system at different temperatures, something that mixed state learning on its own does not. Given access to samples from a thermal state at some temperature, typical samples from the same system at another temperature can be generated by learning the modular Hamiltonian and systematically changing the latent space parameters.

In addition, the presently described techniques are very general and can be employed for any task which involves learning a quantum distribution.

In addition, the presently described techniques include a quantum natural gradient descent method that allows for faster convergence than standard gradient descent methods.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example quantum computing system for generating copies of a target mixed quantum state or a target thermal quantum state.

FIG. 2 is a flow diagram of an example process for generating a copy of a target mixed state of a quantum system.

FIG. 3 is a flow diagram of an example process for performing gradient descent to determine values of variational parameters that optimize the value of a loss function.

FIG. 4 is a block diagram showing an example flow of information for training a parameterized mixed state model to output a target mixed quantum state.

FIG. 5 is a flow diagram of an example process for generating a copy of a target thermal quantum state.

FIG. 6 is a block diagram showing an example flow of information for training a parameterized mixed state model to output a target thermal quantum state.

### DETAILED DESCRIPTION

### Overview

This specification describes two new classes of quantum machine learning algorithms a Quantum Variational Thermalizer and a Quantum Hamiltonian-Based generative modelling algorithm.

The Quantum Variational Thermalizer is a hybrid quantum-classical variational algorithm for the preparation of thermal states of quantum systems. Given a target Hamiltonian and a target inverse temperature, application of the Quantum Variational Thermalizer algorithm produces a quantum state that is an approximation to the thermal state. The approximation is characterized by the target Hamiltonian and target inverse temperature and is obtained by minimizing the free energy of a mixed quantum state whose entropy is known analytically.

The Quantum Hamiltonian-Based algorithm is a hybrid quantum-classical algorithm for the unsupervised learning quantum mixed states. Given access to either copies of the quantum system in quantum memory or measurement statistics about a quantum state, the Quantum Hamiltonian-Based algorithm is a generative model that can be applied to create approximations of the mixed state on a quantum computer. The Quantum Hamiltonian-Based algorithm uses Quantum Relative Entropy as the learning objective. Unlike other algorithms, e.g., energy based models such as the Boltzmann machine, the quantum relative entropy is efficient to directly estimate, e.g., without relying on bounds, due to the particular construction of the Quantum Hamiltonian-Based algorithm.

### Example Hardware for Generating a Copy of a Target Mixed Quantum State or a Target Thermal Quantum State

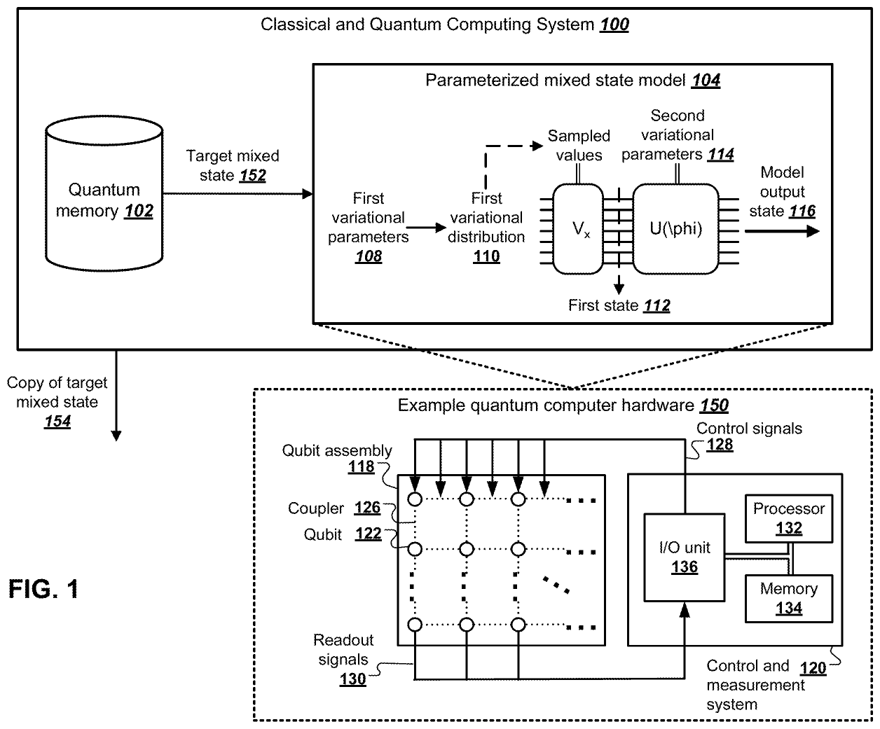

FIG. 1 shows a conceptual block diagram of an example classical and quantum computing system 100 for generating copies of a target mixed state. The example system 100 is an example of a system implemented as classical and quantum computer programs on one or more classical computers and quantum computing devices in one or more locations, in which the systems, components, and techniques described below can be implemented.

The example system 100 includes a quantum memory 102 and a parameterized mixed state model 104. The quantum memory 102 stores data (quantum or classical data) representing the target quantum mixed state 152.

The parameterized mixed state model 104 is a quantum computing device that processes classical and quantum information to perform hybrid quantum-probabilistic inference and, once trained, outputs a quantum state 154 that features the quantum correlations and classical correlations of a target quantum mixed state 152.

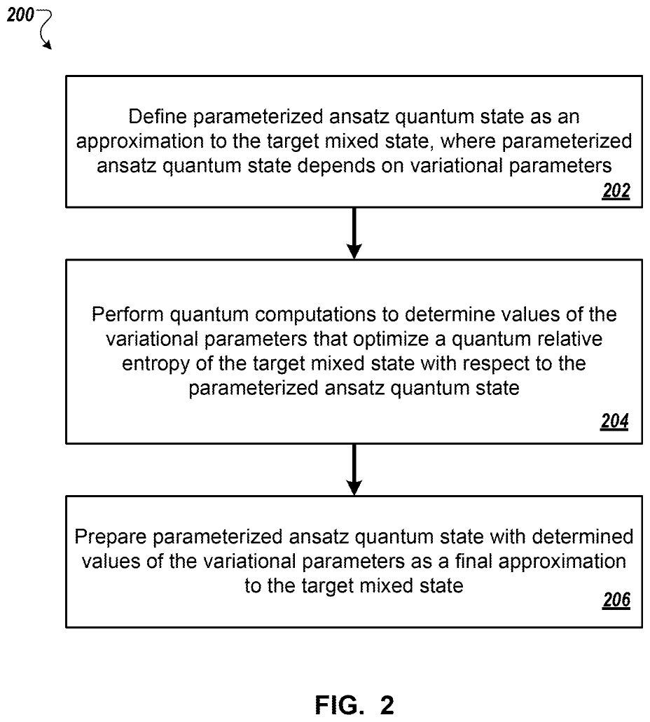

In some implementations the parameterized mixed state model 104 can be a Quantum Hamiltonian-based model (QHBM). For example, the parameterized mixed state model 104 can receive classical data representing variational parameters 108, e.g., the variational parameters {θ} as described below with reference to FIGS. 2-6. The variational parameters 108 can define a variational distribution 110, e.g., p_{θ}(x) as described below with reference to FIG. 2. Values of x can be sampled from the variational distribution 110 and used to define respective unitary operators Vₓ. Each unitary operator Vₓ physically corresponds to a respective quantum circuit (including multiple quantum logic gates) that, when applied to a register of qubits in an initial quantum state, e.g., the zero state, produces a respective computational basis state |x [symbol] and corresponds to the sampled value x˜p_{θ}(x) on a given run. That is, the variational parameters 108 can be used to produce a first (mixed) quantum state 112, e.g., \hat{ρ}_{θ}=Σₓp_{θ}(x)|x [symbol] [symbol] x| as described below with reference to FIG. 2.

In some implementations the values of x can be sampled using a (classical) energy based model where

$${p}_{θ} ( x ) = \frac{1}{{Z}_{θ}} {e}^{- {E}_{θ} ( x )}$$

and E_{θ}(x) represents a (classical) energy function (which can be differentiable). The energy based model can be used to generate a corresponding latent quantum state through classical sampling and preparation of computational basis states, as described above. The energy based model can also define a latent modular Hamiltonian \hat{K}_{θ}=ρₓE_{θ}(x)|x [symbol] [symbol] x| where expectation values of this operator can be determined using the energy function. Other implementations of a QHBM could also be used.

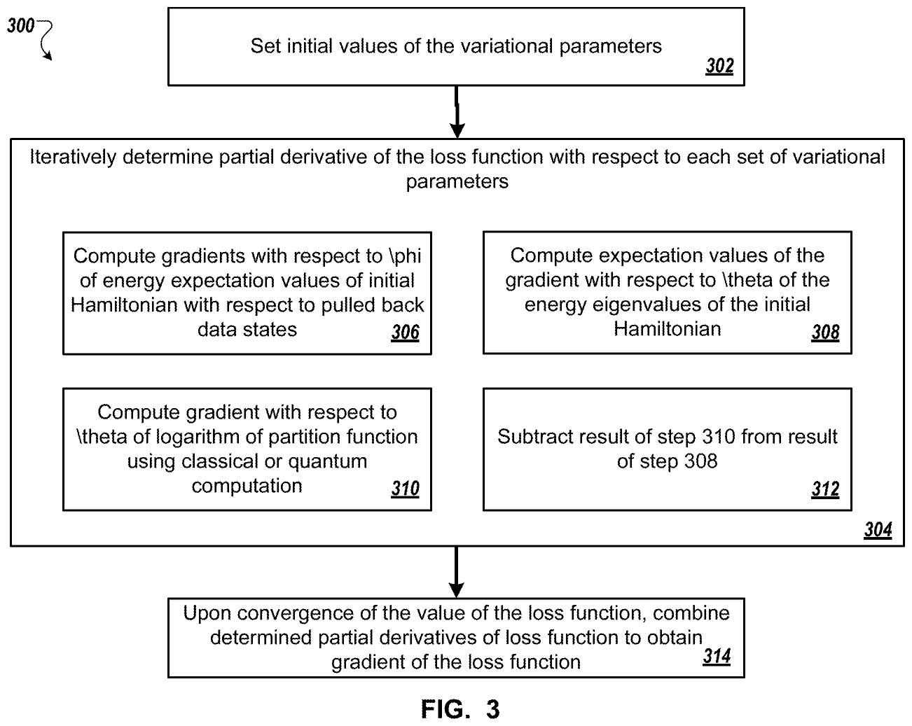

The parameterized mixed state model 104 can then receive classical data representing variational parameters 114, e.g., the variational parameters {φ} as described below with reference to FIGS. 2-6. The variational parameters 114 define a parameterized unitary operator U_{φ}. The parameterized unitary operator U_{φ} physically corresponds to a respective quantum circuit (including one or more quantum logic gates) which, when applied to the first state 112, produces a model output state 116, e.g., \hat{ρ}_{θφ} as described below with reference to FIG. 2. Because of the relationship between the first quantum state 112 and the parameterized unitary operator U_{φ}, the parameterized unitary operator U_{φ} is also referred to herein as a quantum neural network through which the first quantum state 112 can be passed to output a corresponding second (mixed) quantum state 116. Further details regarding the components of and operations performed by the parameterized mixed state model 104 are described below with reference to FIGS. 2 and 3.

Example quantum computer hardware 150 includes hardware components that can be used to physically implement the parameterized mixed state model 104, and generally to perform the classical and quantum computation operations described in this specification according to some implementations. The example hardware 150 is intended to represent various forms of hybrid classical-quantum computing devices. The components shown here, their connections and relationships, and their functions, are exemplary only, and do not limit implementations of the inventions described and/or claimed in this document.

The example quantum computer hardware 150 includes a qubit assembly 118 and a control and measurement system 120. The qubit assembly includes multiple qubits, e.g., qubit 122, that are used to perform algorithmic operations or quantum computations. While the qubits shown in FIG. 1 are arranged in a rectangular array, this is a schematic depiction and is not intended to be limiting. The qubit assembly 118 also includes adjustable coupling elements, e.g., coupler 126, that allow for interactions between coupled qubits. In the schematic depiction of FIG. 1, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device (or a multi-level quantum system or device of which two levels are utilized) having levels representing logical values of 0 and 1. The specific physical realization of the multiple qubits and how they interact with one another is dependent on a variety of factors including the type of the quantum computing device included in example system 100 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits can be realized via superconducting qubits or semi-conducting qubits, e.g., superconducting transmon states. As another example, in a NMR quantum computer the qubits can be realized via nuclear spin states.

In some implementations a quantum computation can proceed by initializing the qubits in a selected initial state and applying a sequence of unitary operators on the qubits. Applying a unitary operator to a quantum state can include applying a corresponding sequence of quantum logic gates to the qubits. Example quantum logic gates include single-qubit gates, e.g., Pauli-X, Pauli-Y, Pauli-Z (also referred to as X, Y, Z), Hadamard and S gates, two-qubit gates, e.g., controlled-X, controlled-Y, controlled-Z (also referred to as CX, CY, CZ), and gates involving three or more qubits, e.g., Toffoli gates. The quantum logic gates can be implemented by applying control signals 128 generated by the control and measurement system 120 to the qubits and to the couplers.

For example, in some implementations the qubits in the qubit assembly 118 can be frequency tuneable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency can put the qubit into a state where it does not strongly interact with other qubits, and where it can be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tuneable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions can be performed in order to perform multi-qubit gates.

The type of control signals 128 used depends on the physical realizations of the qubits. For example, the control signals can include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 128. The measurements cause readout signals 130 representing measurement results to be communicated back to the measurement and control system 120. The readout signals 130 can include RF, microwave, or optical signals depending on the physical scheme for the quantum computing device and/or the qubits. For convenience, the control signals 128 and readout signals 130 shown in FIG. 1 are depicted as addressing only selected elements of the qubit assembly (e.g., the top and bottom rows), but during operation the control signals 128 and readout signals 130 can address each element in the qubit assembly 118.

The control and measurement system 120 is an example of a classical computer system that can be used to perform various operations on the qubit assembly 118, as described above, as well as other classical subroutines or computations. The control and measurement system 120 includes one or more classical processors, e.g., classical processor 132, one or more memories, e.g., memory 134, and one or more I/O units, e.g., I/O unit 136, connected by one or more data buses. The control and measurement system 120 can be programmed to send sequences of control signals 128 to the qubit assembly, e.g. to carry out a selected series of quantum gate operations, and to receive sequences of readout signals 130 from the qubit assembly, e.g. as part of performing measurement operations.

The processor 132 is configured to process instructions for execution within the control and measurement system 120. In some implementations, the processor 132 is a single-threaded processor. In other implementations, the processor 132 is a multi-threaded processor. The processor 132 is capable of processing instructions stored in the memory 134.

The memory 134 stores information within the control and measurement system 120. In some implementations, the memory 134 includes a computer-readable medium, a volatile memory unit, and/or a non-volatile memory unit. In some cases, the memory 134 can include storage devices capable of providing mass storage for the system 120, e.g. a hard disk device, an optical disk device, a storage device that is shared over a network by multiple computing devices (e.g., a cloud storage device), and/or some other large capacity storage device.

The input/output device 136 provides input/output operations for the control and measurement system 120. The input/output device 136 can include D/A converters, A/D converters, and RF/microwave/optical signal generators, transmitters, and receivers, whereby to send control signals 128 to and receive readout signals 130 from the qubit assembly, as appropriate for the physical scheme for the quantum computer. In some implementations, the input/output device 136 can also include one or more network interface devices, e.g., an Ethernet card, a serial communication device, e.g., an RS-232 port, and/or a wireless interface device, e.g., an 802.11 card. In some implementations, the input/output device 136 can include driver devices configured to receive input data and send output data to other external devices, e.g., keyboard, printer and display devices.

Although an example control and measurement system 120 has been depicted in FIG. 1, implementations of the subject matter and the functional operations described in this specification can be implemented in other types of digital electronic circuitry, or in computer software, firmware, or hardware, including the structures disclosed in this specification and their structural equivalents, or in combinations of one or more of them.

### Programming the Hardware: an Example Process for Generating a Copy of a Target Mixed Quantum State

FIG. 2 is a flow diagram of an example process 200 for generating a copy of a target mixed state of a quantum system. The generated copy of the target mixed state will replicate the statistics and correlation structure of the target mixed state from which the system has access to a finite number of samples from a corresponding data distribution, e.g., as stored as quantum data in quantum memory. The target mixed state [symbol] can be a probabilistic mixture of quantum states represented by a data distribution. For example, the obtained data can include data representing a target mixed state given by [symbol] = [symbol] where p_{d} a represents probability of obtaining pure state [symbol] from a dataset [symbol] that represents a set of samples drawn from an underlying distribution.

For convenience, the process 200 will be described as being performed by a system of one or more classical and quantum computing devices located in one or more locations. For example, a quantum computation system, e.g., the system 100 of FIG. 1, appropriately programmed in accordance with this specification, can perform the process 200.

The system prepares a parameterized ansatz quantum state \hat{ρ}_{θφ} as an initial approximation to the target mixed state (step 202). To prepare the parameterized ansatz quantum state \hat{ρ}_{θφ}, the system selects (or receives data indicating a selection of) a first set of variational parameters {θ} and defines an initial Hamiltonian \hat{K}_{θ} using the selected first set of variational parameters. The first set of variational parameters {θ} are also referred to herein as latent variational parameters. Because of its dependency on the first set of variational parameters, the initial Hamiltonian \hat{K}_{θ} is also referred to herein as a latent modular Hamiltonian. The initial Hamiltonian \hat{K}_{θ} defines a corresponding latent quantum state ρ_{θ}. In some implementations the latent quantum state can be based on a parametric set of probability distributions, for example an exponential family. The parametric set of probability distributions can be classically sampled. In some cases the latent quantum state is a diagonal quantum state, where diagonal elements of the diagonal quantum state include sampled values of the parametric set of probability distributions. As an example, in some implementation the initial Hamiltonian gₒ defines a corresponding latent quantum state ρ_{θ} as

$${ρ}_{θ} = \frac{1}{{Z}_{θ}} {e}^{- {\hat{K}}_{θ}} with {Z}_{θ} = t r ( {e}^{- {\hat{K}}_{θ}} ) . \qquad ( 1 )$$

That is, the latent quantum state ρ_{θ} can be a thermal state of the initial Hamiltonian \hat{K}_{θ}. For an eigenbasis Σₓ|x [symbol] [symbol] x|, the initial Hamiltonian \hat{K}_{θ} and latent quantum state ρ_{θ} can be represented as \hat{K}_{θ}=ΣₓR_{θ}(x)|x [symbol] [symbol] x| and \hat{ρ}_{θ}=Σₓp_{θ}(x)|x [symbol] [symbol] x| with

$${p}_{θ} ( x ) = \frac{1}{{Z}_{θ}} {e}^{- {R}_{θ} ( x )} .$$

In some implementations the initial Hamiltonian \hat{K}_{θ} can be realized by qudit operators that are diagonal in the computational basis. In other implementations the initial Hamiltonian \hat{K}_{θ} can be based on number operators of continuous variable quantum modes or harmonic oscillators.

The system can select the first set of variational parameters {θ} based on a suitable known ansatz state or known class of ansatz states that can be efficiently generated using the initial Hamiltonian, e.g., states that the system's quantum computer can prepare with low complexity. For example, the first set of variational parameters can include parameters corresponding to energy eigenvalues of the Hamiltonian. As another example, the first set of variational parameters can include parameters that correspond to values of control parameters that are used to operate the first quantum system, e.g., values of control parameters that determine interaction strengths between qubits included in the first quantum system or magnetic field strengths that are externally applied to the first quantum system.

In some implementations the latent quantum state ρ_{θ} can be a factorized (separated) latent state ρ_{θ}=⊗ⱼ₌₁^{N}ρⱼ(θⱼ) where the total quantum system is separated into N smaller dimensional subsystems, each with a respective set of variational parameters θⱼ for which the mixed states of the subsystems ρⱼ(θⱼ) are uncorrelated. This form can be beneficial since, due to the tensor product structure, the latent modular Hamiltonian \hat{K}_{θ} becomes a sum of modular Hamiltonians of the subsystems. Such a sum decomposition can be useful when estimating the expectation values of the modular Hamiltonian, since the expectation value becomes a sum of expectation values of the subsystem's modular Hamiltonians. Further, the corresponding partition function Z_{θ} becomes a product of the subsystem partition functions and so the logarithm of the partition function becomes a sum. In addition, the entropy of the latent state (and therefore, in turn, the parameterized ansatz quantum state) becomes additive over the entropies of the subsystem.

This can be convenient because estimating N entropies of states in d-dimensional Hilbert space is generally simpler than computing the entropy of a state in d^{N}-dimensional space. Another feature of a factorized state is that the number of parameters used to describe such a distribution is linear in the number of subsystems N (where the exact number of parameters depends on the structure of the states within each subsystem.) In addition, by learning a de-correlated (in terms of both entanglement and classical correlations) representation in latent space, a representation which has a natural orthogonal basis for its latent space is learned, allowing for latent space interpolation, independent component analysis, compression code learning, principal component analysis, and many other spin-off applications. In classical machine learning, this is known as a disentangled representation.

The system selects (or receives data indicating a selection of) a second set of variational parameters {φ} and defines (or receives data defining) a parameterized unitary operator U_{φ} using the selected second set of variational parameters. The second set of variational parameters {φ} are also referred to herein as model variational parameters. In some implementations the parameterized unitary operator U_{φ} represents a parameterized quantum circuit that includes one or more quantum logic gates, e.g., one or more single qubit rotations and two-qubit rotations between adjacent qubits. In these implementations the second set of variational parameters {φ} can include parameters of one or more quantum logic gates included in the parameterized quantum circuit, e.g., rotation angles of respective rotation gates.

The parameterized unitary operator U_{φ} can be applied to the latent quantum state ρ_{φ} to incorporate quantum correlations and obtain the parameterized mixed state

\hat{ρ}_{θφ}=U_{φ}ρ_{θ}U_{φ}^{†}. (2)

For example, the parameterized unitary operator U_{φ} can transform the initial Hamiltonian \hat{K}_{θ} to obtain a target Hamiltonian \hat{K}_{θ,φ}=U_{φ}\hat{K}_{θ}U_{φ}^{†} that depends on both the first set {θ} and second set {φ} of variational parameters. In some implementations the target Hamiltonian \hat{K}_{θ,φ} can be a sum of sub-Hamiltonians \hat{K}_{θ,φ}=Σⱼ₌₁^{r}\hat{K}^{(j)}_{θ}_{^{(j)}}_{, φ}_{^{(j)}} where r represents the total number of sub-terms terms and \hat{K}^{j)}_{θ}_{^{(j)}}_{,φ}_{^{(j)}}=U_{φ}_{^{(j)}}\hat{K}^{(j)}_{θ}_{^{(j)}}U_{φ}_{^{(j)}}^{(j)†} with \hat{K}^{(j)}_{θ}_{^{(j)}}=ΣₓR_{θ}_{^{(j)}}^{(j)}(x)|x [symbol] [symbol] x|, where the U_{φ}_{^{(j)}} can be local unitary operators (e.g., supported on respective sets of neighbouring qubits).

Preparing a quantum system in the latent quantum state ρ_{θ} and performing unitary evolution of the latent quantum state ρ_{θ} according to the unitary operator U_{φ}, outputs the parameterized ansatz quantum state

$${\hat{ρ}}_{θφ} = \frac{1}{{Z}_{θ}} {e}^{- {U}_{φ} {\hat{K}}_{θ} {U}_{φ}^{†}} ≡ \frac{1}{{Z}_{θ}} {e}^{- {\hat{K}}_{θ , φ}} \qquad ( 3 )$$

which depends on both the first set and second set of variational parameters. Because of the relationship between the latent quantum state ρ_{θ} and the parameterized unitary operator U_{φ}, the parameterized unitary operator U_{φ} is also referred to herein as a quantum neural network through which the latent quantum state ρ_{θ} can be passed to produce the parameterized ansatz quantum state \hat{ρ}_{θφ}.

The structure of the parameterized ansatz quantum state \hat{ρ}_{θφ} is analogous to classical energy based models. In such classical energy based models, the variational distribution is of the exponential form

$${p}_{θ} ( x ) = \frac{1}{{Z}_{θ}} {e}^{- {E}_{θ} ( x )}$$

where Z_{θ}=Σₓe^{-E}^{_{θ}}^{(x)} and E_{θ}(x) represents an energy function that is parameterized by a neural network. The network is trained so that samples from p_{θ} mimic those of a target data distribution. In the present quantum Hamiltonian based model, the parameterized modular Hamiltonian operator replaces the classical energy function and the variational model is a thermal state of the parameterized modular Hamiltonian operator. This is why the model is referred to as a quantum Hamiltonian based model instead of an energy based model. The thermal state of the Hamiltonian is designed to replicate the quantum statistics of the target data.

The system determines, by classical and quantum computation, values of the first set of variational parameters and second set of variational parameters that minimize a quantum relative entropy of the target mixed state with respect to the parameterized ansatz quantum state (step 204). That is, the system determines

$${argmin}_{θ , φ} D ( {σ}_{D} \vert \vert {\hat{ρ}}_{θ φ} ) \qquad ( 4 )$$

where [symbol] ( [symbol] ∥\hat{ρ}_{θφ})=(tr( [symbol] log [symbol] )−tr( [symbol] log \hat{ρ}_{θφ}) represents the quantum relative entropy of the target mixed state with respect to the parameterized ansatz quantum state. Due to the positivity of relative entropy, the optimum of the above function is achieved if and only if the variational distribution of the model is equal to the quantum data distribution: [symbol] ( [symbol] ∥\hat{ρ}_{θφ})=0⇔ [symbol] =\hat{ρ}_{θφ}. This is used as a variational principle—the relative entropy is used as a loss function [symbol] _{θφ} and optimal parameters {θ*,φ*} of the model are computed such that [symbol] =\hat{ρ}_{θ*φ*}.

In implementations where the parameterized ansatz quantum state is given by Equation (3) above, the quantum relative entropy of the target mixed state with respect to the parameterized ansatz quantum state is given by [symbol] ( [symbol] ∥\hat{ρ}_{θφ})=−S( [symbol] )+tr( [symbol] \hat{K}_{θ,φ})+log Z_{θ}. The first term S( [symbol] )=−tr( [symbol] log [symbol] ) represents the entropy of the data distribution and is independent of the variational parameters. Therefore, the loss function used by the system does not include this term. The loss function is therefore given by

[symbol]

_{θφ}=tr( [symbol] \hat{K}_{θφ})+log Z_{θ}. (5)

Because the two terms in the loss function represent the quantum cross entropy between the data state [symbol] and the model \hat{K}_{θφ}, the loss function can be referred to as a quantum variational cross entropy loss. Since trace is a cyclic operation, the loss function can also be written as

[symbol]

_{θφ}=tr( [symbol] \hat{K}_{θ})+log Z_{θ} (6)

where [symbol] is referred to herein as a pulled-back data state (which is a quantum state obtained by feeding the state [symbol] through the quantum neural network U_{φ} in reverse (or inverse)). Therefore, the first term of the loss function in Equation (6) is equivalent to the expectation value of the latent modular Hamiltonian with respect to the pulled back data state. In the limit where the model \hat{K}_{θφ} approximates the state [symbol] , the loss function converges to the entropy of the data. This means that after convergence of training the variational parameters, an estimate of the entropy of the state [symbol] is obtained by observing the value to which the loss function converges to. This can be combined with quantum simulation techniques for estimation of entropies and other information theoretic quantities using quantum computers.

Returning to step 204 of FIG. 2, to determine values of the first set of variational parameters and second set of variational parameters that minimize the quantum relative entropy of the target mixed state with respect to the parameterized ansatz quantum state, the system performs an iterative optimization of the loss function [symbol] _{θφ}, where at each iteration an optimization task determines updated values of the variational parameters of the loss function [symbol] _{θφ} to obtain a smaller value of the loss function at each iteration. That is, the system performs an iterative optimization strategy given by Equation (7) below.

$${min}_{θφ} {ℒ}_{θ φ} = {min}_{θφ} ( {σ}_{D} {\hat{K}}_{θφ} + log {Z}_{θ} ) . \qquad ( 7 )$$

The iterative optimization is performed until the value of the loss function converges, e.g., to within a predetermined threshold.

To perform the iterative optimization of the loss function, the system performs gradient descent. This includes, at each iteration, computing gradients of the loss function [symbol] _{θφ} with respect to each set of variational parameters.

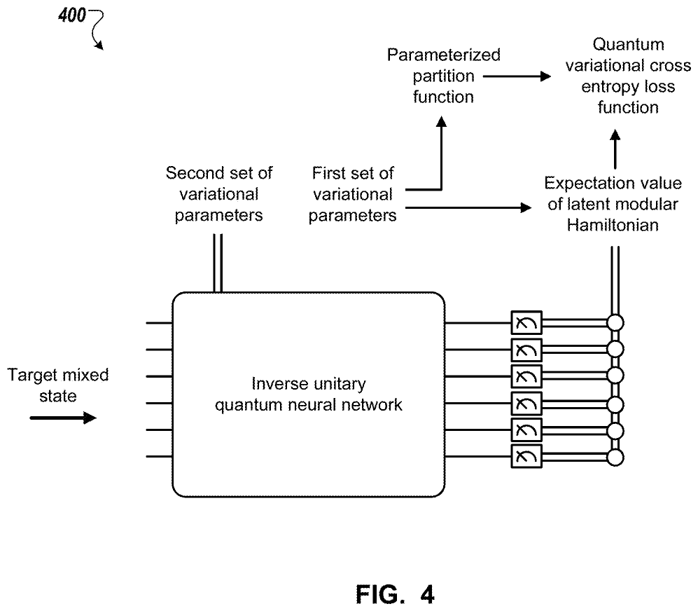

Generally, computing gradients of the loss function [symbol] _{θφ} with respect to each set of variational parameters for a particular iteration includes performing classical and quantum computations such as: physically preparing quantum states for varying values of the variational parameters, e.g., physically generating the parameterized mixed state according to values of the parameters obtained from initial input data or a previous iteration, applying quantum operations to the prepared quantum states to obtain so called “pulled back” quantum states, e.g., applying quantum circuits corresponding to an inverse of the above described parameterized unitary operator to the respective prepared quantum states (where the parameterized unitary operator can be defined according to values of the variational parameters obtained from a previous or current iteration), and determining expectation values of respective operators with respect to the pulled back quantum states using additional quantum operations and measurements or classical operations. An example process for performing gradient descent to determine values of the variational parameters {θ, φ} that optimize the value of the loss function [symbol] _{θφ} is described below with reference to FIG. 3. A block diagram showing the information flow for training a parameterized mixed state model using the above described techniques is described below with reference to FIG. 4.

The system prepares the parameterized ansatz quantum state with the determined values of the first set of variational parameters and second set of variational parameters as a final approximation to the target mixed state (step 206), e.g., using the parameterized mixed state model 104 of FIG. 1.

FIG. 3 is a flow diagram of an example process 300 for performing gradient descent to determine values of the variational parameters (as described above with reference to example process 200 of FIG. 2) that optimize the value of the loss function (described above with reference to example process 200 of FIG. 2.) For convenience, the process 300 will be described as being performed by a system of one or more classical and quantum computing devices located in one or more locations. For example, a quantum computation system, e.g., the system 100 of FIG. 1, appropriately programmed in accordance with this specification, can perform the process 300.

The system sets (or receives data specifying) initial values of the variational parameters {θ, φ} (step 302).

The system iteratively determines a gradient of the loss function [symbol] _{θφ} with respect to the variational parameters {θ, φ} until convergence criteria are met, e.g., until the value of the loss function converges, e.g., to within a predetermined threshold. Determining a gradient of the loss function [symbol] _{θφ} with respect to the variational parameters {θ, φ} includes, at each iteration, determining a partial derivative of the loss function with respect to each of the sets of variational parameters θ, φ (step 304).

The partial derivative of the loss function [symbol] _{θφ} with respect to the second set φ of the variational parameters e.g., ∇_{φ} [symbol] _{θφ}, can be given as

$$\begin{matrix}{∇}_{φ} {L}_{θφ} = {∇}_{φ} ( tr ( {\hat{σ}}_{D} {\hat{K}}_{θφ} ) ) \\ = {∇}_{φ} ( tr ( {\hat{σ}}_{D} {U}_{φ} {\hat{K}}_{θ} {U}_{φ}^{†} ) ) \\ = {∇}_{φ} ( t r ( {U}_{φ}^{†} {\hat{σ}}_{D} {U}_{φ} {\hat{K}}_{θ} ) ) .\end{matrix} \qquad ( 8 )$$

Therefore, to determine the partial derivative of the loss function [symbol] _{θφ} with respect to the second set φ of variational parameters, the system computes the gradient (with respect to φ) of the energy expectation of the initial Hamiltonian \hat{K}_{θ} (evaluated using values of θ determined in the previous iteration) with respect to various quantum neural network parameter values of a first pulled back data state [symbol] , where the first pulled back data state can be generated by applying a quantum circuit [symbol] to the target mixed state [symbol] , the quantum circuit U_{φ}^{†} representing an inverse of the first parameterized unitary operator U_{φ} (step 306). The system can compute this gradient using quantum and classical computations. For example, the system can repeatedly:
i. prepare (i.e., physically generate) the target mixed state [symbol] ,
ii. back propagate the prepared target mixed state [symbol] through the quantum neural network U_{φ} (for a value of φ as specified by a finite difference method or parameter-shift gradient estimator), e.g., apply a quantum circuit U_{φ}^{†} to the target mixed state [symbol] to obtain the first pulled back data state [symbol] , and
iii. measure the energy of the initial Hamiltonian \hat{K}_{θ} with respect to the first pulled back data state [symbol] ,
   according to values of φ determined by the finite difference method or parameter-shift gradient estimator. For example, in the case where the unitary QNN ansatz is a hardware-efficient ansatz, e.g., a QNN whose parameterized operations are independently parameterized and are of the form of simple exponentials of single Pauli operators e.g.

$${e}^{- \frac{i φ P}{2}} ,$$

application of the parameter shift rule includes evaluating

∂_{φ}_{ⱼ} [symbol] (θ, φ)=∂_{φ}_{ⱼ}tr( [symbol] )=½tr( [symbol] _{+Δ}_{^{j}})−½tr( [symbol] _{-Δ}_{^{j}}) (9)

where

$${( {Δ}^{j} )}_{k} = \frac{π}{2} {δ}_{j k}$$

that is Δ^{j} represents a

$$\frac{π}{2}$$

magnitude shift in tne j-th parameter. The particular parameter shift rule will depend on the ansatz used.

In some implementations the partial derivative of the loss function [symbol] _{θφ} with respect to the first set 0 of the variational parameters e.g., ∇_{θ} [symbol] _{θφ}, can be given as

∇_{θ} [symbol] _{θφ}=∇_{θ}(tr( [symbol] \hat{K}_{θφ}))+∇_{θ} log Z_{θ} (10)

The first term ∇_{θ}(tr( [symbol] \hat{K}_{θφ})) can be expanded as

$$\begin{matrix}{∇}_{θ} ( tr ( {\hat{σ}}_{D} {\hat{K}}_{θ φ} ) ) = {∇}_{θ} ( tr ( {\hat{σ}}_{D} {U}_{φ} {\hat{K}}_{θ} {U}_{φ}^{†} ) ) \\ = {∇}_{θ} ( tr ( {U}_{φ}^{†} {\hat{σ}}_{D} {U}_{φ} {\hat{K}}_{θ} ) ) \\ = {\sum }_{x} {∇}_{θ} {R}_{θ} ( x ) 〈 \vert {U}_{φ}^{†} {\hat{σ}}_{D} {U}_{φ} \vert x 〉 .\end{matrix} \qquad ( 11 )$$

Therefore, in these implementations, to determine the partial derivative of the loss function [symbol] _{θφ} with respect to the first set θ of variational parameters, the system computes expectation values of the gradient (with respect to θ) of the energy eigenvalues R_{θ}(x) of the initial Hamiltonian \hat{K}_{θ} (step 308). For each eigenstate |x [symbol] in the eigenbasis Σₓ|x [symbol] [symbol] x| of the initial Hamiltonian \hat{K}_{θ}, the system determines the gradient (with respect to θ) of the corresponding eigenvalue R_{θ}(x) multiplied by an probability of the first pulled back state [symbol] producing the eigenstate (step 308). The system can compute this expected value of the gradient using quantum and classical computations. For example, for each eigenstate in the eigenbasis and according to a finite difference method or parameter-shift gradient estimator, the system can repeatedly
i. prepare (i.e., physically generate) the target mixed state [symbol] ,
ii. back propagate the prepared target mixed state [symbol] through the quantum neural network U_{φ}, e.g., apply a quantum circuit U_{φ}^{†} to the target mixed state [symbol] , the quantum circuit representing an inverse of the first parameterized unitary operator U_{φ} with values of φ set to those determined in the previous iteration, to obtain the first pulled back data state [symbol] , and
iii. measure the corresponding energy eigenvalue of the initial Hamiltonian \hat{K}_{θ} (for a value of θ as specified by the finite difference method or parameter-shift gradient estimator) in the energy eigenbasis with respect to the first pulled back data state [symbol] ,
   to determine the expectation value of the gradient of the energy eigenvalues R_{θ}(x) of the initial Hamiltonian.

To determine the gradient of the logarithm of the partition function (the second term in the right hand side of Equation (9)) the system can perform classical or quantum computations to evaluate the gradient analytically (step 310). For example, in some implementations the system can compute

$$\begin{matrix}{∇}_{{θ}_{m}} log {Z}_{θ} = {∇}_{{θ}_{m}} log [ tr ( {e}^{- {K}_{m} ( {θ}_{m} )} ) ] \\ = \frac{1}{{Z}_{m} ( {θ}_{m} )} {∇}_{{θ}_{m}} t r ( {e}^{- {K}_{m} ( {θ}_{m} )} ) \\ = - \frac{1}{{Z}_{m} ( {θ}_{m} )} tr ( {e}^{- {K}_{m} ( {θ}_{m} )} {∇}_{{θ}_{m}} {K}_{m} ( {θ}_{m} ) ) \\ = - \frac{1}{{Z}_{m} ( {θ}_{m} )} tr ( {e}^{- {θ}_{m} {M}_{m}} {M}_{m} )\end{matrix} \qquad ( 12 )$$

where Kₘ(θₘ)=θₘMₘ, analytically using knowledge of the spectrum of Mₘ.

The system subtracts the expectation value of the gradient as determined at step 310 from the expectation value of the gradient as determined at step 308 to obtain ∇_{θ} [symbol] _{θφ} (step 312).

In other implementations the partial derivative of the loss function [symbol] _{θφ} with respect to the first set θ of the variational parameters e.g., ∇_{θ} [symbol] _{θφ}, can be given as

[symbol]

$$\begin{matrix}{∇}_{θ} {ℒ}_{QMHL} ( θ , φ ) = {∇}_{θ} tr ( [ {\hat{U}}^{†} ( φ ) {\hat{σ}}_{D} \hat{U} ( φ ) ] {\hat{K}}_{θ} ) + {∇}_{θ} log ( {θ}_{} ) \\ = {∇}_{θ} {𝔼}_{x \sim {σ}_{φ} ( x )} [ {E}_{θ} ( x ) ] + {∇}_{θ} log ( {θ}_{} ) \\ = {𝔼}_{x \sim {σ}_{φ} ( x )} [ {∇}_{θ} {E}_{θ} ( x ) ] + ( \frac{1}{{θ}_{}} ) {∇}_{θ} {θ}_{} \\ = {𝔼}_{x \sim {σ}_{φ} ( x )} [ {∇}_{θ} {E}_{θ} ( x ) ] + ( \frac{1}{{θ}_{}} ) {∇}_{θ} [ {\sum }_{y ∈ Ω} {e}^{- {E}_{θ} ( y )} ] \\ = {𝔼}_{x \sim {σ}_{φ} ( x )} [ {∇}_{θ} {E}_{θ} ( x ) ] - ( \frac{1}{{θ}_{}} ) {\sum }_{y ∈ Ω} {e}^{- {E}_{θ} ( y )} [ {∇}_{θ} {E}_{θ} ( y ) ] ] \\ = {𝔼}_{x \sim {σ}_{φ} ( x )} [ {∇}_{θ} {E}_{θ} ( x ) ] - {𝔼}_{y \sim {p}_{θ} ( y )} [ {∇}_{θ} {E}_{θ} ( y ) ]\end{matrix} \qquad ( 13 )$$

where σ_{φ}(x)† [symbol] x≡U_{φ}^{†} [symbol] |x [symbol] . Because the energy function E_{θ}(x) can be chosen to be differentiable according to its parameters, the gradient of the energy function at any given point x can be efficiently queried. The difference of the expected value of this gradient of the energy function with respect to the pulled-back data state vs the classically sample-able Boltzmann distribution can then be taken.

In this derivation of the partial derivative of the loss function [symbol] _{θφ} with respect to the first set θ of the variational parameters, computation of the partition function is not required. This is in contrast to cases where zeroth order information about the loss function (i.e. the value of the function itself rather than its gradients) is used. Here first order information about the loss can be obtained without the need for estimation of the zeroth order.

Upon convergence of the value of the loss function, the system combines the determined partial derivatives of the loss function with respect to each of the sets of variational parameters θ, φ (computed at steps 306 and 312) to obtain a gradient of the loss function (step 314).

FIG. 4 is a block diagram 400 showing an example flow of information when training a parameterized mixed state model, e.g., parameterized mixed state model 104 of FIG. 1. The first set of variational parameters determine the latent space distribution and the modular latent Hamiltonian. From the known latent distribution, estimates of the parameterized partition function log Z_{θ} can be obtained using a classical device. The inverse unitary quantum neural network can be applied to the target mixed state and the expectation value of the latent modular Hamiltonian can be obtained at the output via multiple runs of inference and measurement on the quantum device. The partition function and modular expectation are then combined to produce the quantum variational cross entropy loss function.

### Programming the Hardware: an Example Process for Generating a Copy of a Target Thermal Quantum State

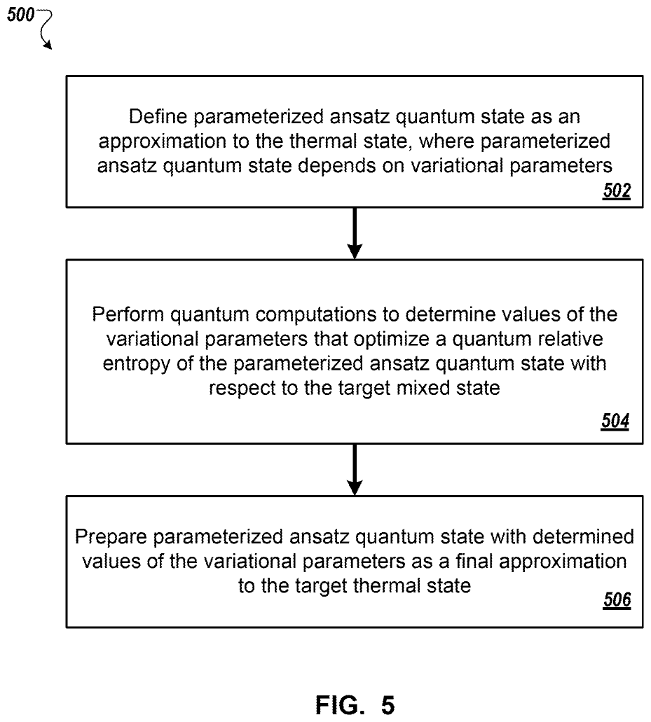

FIG. 5 is a flow diagram of an example process 500 for generating a copy of a target thermal quantum state. The generated copy of the thermal quantum state will replicate the statistics and correlation structure of the target thermal quantum state from which the system has access to a finite number of samples from a corresponding data distribution, e.g., as stored as quantum data in quantum memory. The target thermal quantum state \hat{σ}_{β} is defined by a target Hamiltonian and a target temperature. For example, the target thermal state can be given by

$${σ}_{β} = \frac{1}{{Z}_{β}} {e}^{- β H} , {Z}_{β} = t r ( {e}^{- β H} ) \qquad ( 14 )$$

where β=1/T represents the inverse of the target temperature T, H represents the target Hamiltonian and Z_{β} represents a thermal partition function.

For convenience, the process 500 will be described as being performed by a system of one or more classical and quantum computing devices located in one or more locations. For example, a quantum computation system, e.g., the system 100 of FIG. 1, appropriately programmed in accordance with this specification, can perform the process 200.

The system prepares a parameterized ansatz quantum state \hat{ρ}_{θφ} as an initial approximation to the target thermal quantum state (step 502). In some implementations the parameterized ansatz quantum state \hat{ρ}_{θφ} can be prepared using the techniques described at step 202 of example process 200, however other more general techniques that produce a quantum state that is dependent on a first and second set of variational parameters can also be used.

The system determines, by classical and quantum computation, values of the first set of variational parameters and second set of variational parameters that minimize a quantum relative entropy of the parameterized ansatz quantum state with respect to the target thermal quantum state (step 504). That is, the system determines

$${arg min}_{θ , φ} D ( {\hat{ρ}}_{θ φ} \vert \vert {σ}_{β} ) \qquad ( 15 )$$

where [symbol] (\hat{ρ}_{θφ}∥σ_{β})=tr(\hat{ρ}_{θφ} log \hat{ρ}_{θφ})−tr(\hat{ρ}_{θφ} log σ_{β}) represents the quantum relative entropy of the parameterized ansatz quantum state with respect to the target thermal quantum state. The quantum relative entropy of the parameterized ansatz quantum state with respect to the target thermal quantum state can be given by

[symbol]

(\hat{ρ}_{θφ}∥σ_{β})=−S(\hat{ρ}_{θφ})+βtr(\hat{ρ}_{θφ}H)+log Z_{β}, (16)

with S(\hat{ρ}_{θφ})=−tr(\hat{ρ}_{θφ} log \hat{ρ}_{θφ}), and is referred to as the quantum relative free energy of the model \hat{ρ}_{θφ} with respect to the target Hamiltonian H. As described above with reference to step 204 of example process 200, due to the positivity of relative entropy, the optimum of the function given in Equation (13) is achieved if and only if the variational distribution of the model is equal to the quantum data distribution: [symbol] (\hat{ρ}_{θφ}∥σ_{β})=0⇔σ_{β}=\hat{ρ}_{θφ}. This is used as a variational principle—the relative entropy is used as a loss function [symbol] _{θφ} and optimal parameters {θ*, φ*} of the model are computed such that σ_{β}=\hat{ρ}_{θ*φ*}.

The last term log Z_{β} is independent of the variational parameters. Therefore, the loss function used by the system does not include this term. The loss function is therefore given by

[symbol]

_{θφ}=βtr(\hat{ρ}_{θφ}H)−S(\hat{ρ}_{θφ}). (17)

To determine values of the first set of variational parameters and second set of variational parameters that minimize the quantum relative entropy of the parameterized ansatz quantum state with respect to the target thermal quantum state, the system performs an iterative optimization of the loss function [symbol] _{θφ} (given in Equation (15)), where at each iteration an optimization task determines updated values of the variational parameters of the loss function [symbol] _{θφ} to obtain a smaller value of the loss function at each iteration. That is, the system performs an iterative optimization strategy given by Equation (16) below.

$${min}_{θφ} {ℒ}_{θ φ} = {min}_{θφ} ( β t r ( {\hat{ρ}}_{θφ} H ) - S ( {\hat{ρ}}_{θφ} ) ) . \qquad ( 18 )$$

The iterative optimization is performed until the value of the loss function converges, e.g., to within a predetermined threshold.

To perform the iterative optimization of the loss function, the system sets (or receives data specifying) initial values of the variational parameters {θ, φ} (step 504a). The system then iteratively determines a gradient of the loss function [symbol] _{θφ} with respect to the variational parameters {θ, φ} until convergence criteria are met, e.g., until the value of the loss function converges, e.g., to within a predetermined threshold. Determining a gradient of the loss function [symbol] _{θφ} with respect to the variational parameters {θ, φ} includes, at each iteration, determining a partial derivative of the loss function with respect to each of the parameters in the sets of variational parameters θ, φ (step 504b).

In some implementations the system can implement a finite difference method, e.g., a central difference method, to determine the partial derivatives. For example, to determine the partial derivative of the loss function with respect to a parameter θᵢ in the first set of variational parameters at a current iteration, the system can determine

$${∇}_{{θ}_{i}} {ℒ}_{θ φ} \approx \frac{{ℒ}_{θ + ϵ Δ {θ}_{i} , φ} - {ℒ}_{θ - ϵ Δ {θ}_{i} , φ}}{2 ϵ} = \frac{( β tr ( {\hat{ρ}}_{θ + ϵ Δ {θ}_{i} φ} H ) - β tr ( {\hat{ρ}}_{θ - ϵ Δ {θ}_{i} φ} H ) )}{2 ϵ} - \frac{( S ( {\hat{ρ}}_{θ + ϵ Δ {θ}_{i} φ} ) - S ( {\hat{ρ}}_{θ - ϵ Δ {θ}_{i} φ} ) )}{2 ϵ} \qquad ( 19 )$$

where θ, φ take values determined during the previous iteration, ϵ represents a real number and Δθᵢ represents a unit-norm perturbation vector in the i-th direction.

To compute the first term on the RHS of Equation (17) the system can determine tr(\hat{ρ}_{θ+ϵΔθ}_{ᵢ}_{φ}H) by repeatedly preparing the state \hat{ρ}_{θ+ϵΔθ}_{ᵢ}_{φ} and, for each prepared state, measuring the expectation value of the target Hamiltonian with respect to the prepared state. Similarly, the system can determine tr(\hat{ρ}_{θ-ϵΔθ}_{ᵢ}_{φ}H) by repeatedly preparing the state \hat{ρ}_{θ-ϵΔθ}_{ᵢ}_{φ} and, for each prepared state, measuring the expectation value of the target Hamiltonian with respect to the prepared state. The system can then determine an average value of tr(\hat{ρ}_{θ+ϵΔθ}_{ᵢ}_{φ}H) and an average value of tr(\hat{ρ}_{θ-ϵΔθ}_{ᵢ}_{φ}H) using the obtained measurement results, and use these computed averages to compute the first term of Equation (17).

To compute the second term on the RHS of Equation (17) (the entropy of the latent variational distribution) the system can use classically stored information that can be known a priori. Therefore, the number of runs required to estimate the loss function is similar to the number of runs required for the variational quantum eigensolver and other variational algorithms with losses that depend only on expectation values.

Similar techniques can be applied to determine the partial derivative of the loss function with respect to other parameters in the first set of variational parameters and parameters in the second set of variational parameters at each iteration.

In other implementations, to determine a gradient of the loss function [symbol] _{θφ} with respect to the variational parameters θ, the system computes

$$\begin{matrix}{∇}_{{θ}_{i}} {ℒ}_{VQT} ( θ , φ ) = β {∇}_{θ} F ( {( \hat{ρ } )}_{θ φ} ) = β {∇}_{θ} tr ( {\hat{ρ }}_{θ φ} \hat{H} ) - {∇}_{θ} S ( {( \hat{ρ } )}_{θ φ} ) = β {∇}_{θ} tr ( {( \hat{ρ } )}_{θ} \hat{H} φ ) - {∇}_{θ} S ( {\hat{ρ }}_{θ} ) = {∇}_{θ} [ \frac{β}{{Z}_{θ}} tr ( {e}^{- {\hat{K}}_{θ}} {\hat{H}}_{φ} ) + \frac{1}{{Z}_{θ}} tr ( {e}^{- {\hat{K}}_{θ}} log {\hat{ρ }}_{θ} ) ] = {∇}_{θ} [ \frac{β}{{Z}_{θ}} tr ( {e}^{- {\hat{K}}_{θ}} {\hat{H}}_{φ} ) - \frac{1}{{Z}_{θ}} tr ( {e}^{- {\hat{K}}_{θ}} {\hat{K}}_{θ} ) - log {Z}_{θ} ] = {∇}_{θ} [ \frac{1}{{Z}_{θ}} tr [ {e}^{- {\hat{K}}_{θ}} ( β {\hat{H}}_{φ} - {\hat{K}}_{θ} ) ] ] - {∇}_{θ} log {Z}_{θ} = tr [ {e}^{- {\hat{K}}_{θ}} ( β {\hat{H}}_{φ} - {\hat{K}}_{θ} ) ] {∇}_{θ} ( \frac{1}{{Z}_{θ}} ) + ( \frac{1}{{Z}_{θ}} ) {∇}_{θ} tr [ {e}^{- {\hat{K}}_{θ}} ( β {\hat{H}}_{φ} - {\hat{K}}_{θ} ) ] - {∇}_{θ} log {Z}_{θ} = tr [ {e}^{- {\hat{K}}_{θ}} ( β {\hat{H}}_{φ} - {\hat{K}}_{θ} ) ] ( - \frac{1}{\text{?}} ) {∇}_{θ} {Z}_{θ} + ( \frac{1}{{Z}_{θ}} ) {∇}_{θ} tr [ {e}^{- {\hat{K}}_{θ}} ( β {\hat{H}}_{φ} - {\hat{K}}_{θ} ) ] - ( \frac{1}{{Z}_{θ}} ) {∇}_{θ} {Z}_{θ} = - ( \frac{1}{{Z}_{θ}} ) ( 1 + tr [ {\hat{ρ}}_{θ} ( β {\hat{H}}_{φ} - {\hat{K}}_{θ} ) ] ) {∇}_{θ} {Z}_{θ} + ( \frac{1}{{Z}_{θ}} ) {∇}_{θ} tr [ {e}^{- {\hat{K}}_{θ}} ( β {\hat{H}}_{φ} - {\hat{K}}_{θ} ) ] = - ( \frac{1}{{Z}_{θ}} ) ( 1 + {\sum }_{x ∈ Ω} [ {p}_{θ} ( x ) ( β {H}_{φ} ( x ) - {E}_{θ} ( x ) ) ] ) {∇}_{θ} {Z}_{θ} + ( \frac{1}{{Z}_{θ}} ) {∇}_{θ} [ {\sum }_{x ∈ Ω} [ {e}^{- {E}_{θ} ( x )} ( β {H}_{φ} ( x ) - {E}_{θ} ( x ) ) ] ] = - ( \frac{1}{{Z}_{θ}} ) ( 1 + {\sum }_{x ∈ Ω} [ {p}_{θ} ( x ) ( β {H}_{φ} ( x ) - {E}_{θ} ( x ) ) ] ) {∇}_{θ} [ {\sum }_{y ∈ Ω} {e}^{- {E}_{θ} ( y )} ] + ( \frac{1}{{Z}_{θ}} ) {∇}_{θ} ( {\sum }_{x ∈ Ω} [ {e}^{- {E}_{θ} ( x )} ( β {H}_{φ} ( x ) - {E}_{θ} ( x ) ) ] ) = - ( \frac{1}{{Z}_{θ}} ) ( 1 + {\sum }_{x ∈ Ω} [ {p}_{θ} ( x ) ( β {H}_{φ} ( x ) - {E}_{θ} ( x ) ) ] ) [ - {\sum }_{y ∈ Ω} {e}^{- {E}_{θ} ( y )} {∇}_{θ} {E}_{θ} ( y ) ] + ( \frac{1}{{Z}_{θ}} ) ( {\sum }_{x ∈ Ω} [ - [ {∇}_{θ} {E}_{θ} ( x ) ] {e}^{- {K}_{θ} ( x )} ( β {H}_{φ} ( x ) - {E}_{θ} ( x ) ) - {e}^{- {E}_{θ} ( x )} [ {∇}_{θ} {E}_{θ} ( x ) ] ] ) = ( \text{?} + {\sum }_{x ∈ Ω} [ {p}_{θ} ( x ) ( β {H}_{φ} ( x ) - {E}_{θ} ( x ) ) ] ) [ {\sum }_{y ∈ Ω} {p}_{θ} ( y ) {∇}_{θ} {E}_{θ} ( y ) ] - ( {\sum }_{x ∈ Ω} [ {∇}_{θ} {E}_{θ} ( x ) ] {p}_{θ} ( x ) ( \text{?} + β {H}_{φ} ( x ) - {E}_{θ} ( x ) ) ) = {\sum }_{x ∈ Ω} [ {p}_{θ} ( x ) ( β {H}_{φ} ( x ) - {E}_{θ} ( x ) ) ] [ {\sum }_{y ∈ Ω} {p}_{θ} ( y ) {∇}_{θ} {E}_{θ} ( y ) ] - ( {\sum }_{x ∈ Ω} [ {∇}_{θ} {E}_{θ} ( x ) ] {p}_{θ} ( x ) ( β {H}_{φ} ( x ) - {E}_{θ} ( x ) ) ) = {E}_{x ∼ {p}_{θ} ( x )} [ β {H}_{φ} ( x ) - {E}_{θ} ( x ) ] \times {E}_{y ∼ {p}_{θ} ( y )} [ {∇}_{θ} {E}_{{ }_{θ}} ( y ) ] - {E}_{x ∼ {p}_{θ ( x )}} [ ( β {H}_{φ} ( x ) - {E}_{θ} ( x ) ) {∇}_{θ} {E}_{θ} ( x ) ] & ( 20 ) \\ \text{?} \text{indicates text missing or illegible when filed} & \end{matrix}$$

where H_{φ}≡U_{φ}^{†}HU_{φ} represents a push-forward Hamiltonian and H_{φ}(x)≡ [symbol] x|U_{φ}^{†}HU_{φ}|x [symbol] represents a push-forward Hamiltonian expectation per basis state, which requires the use of a quantum computer to evaluate.

The gradient of the loss function [symbol] _{θφ} with respect to the variational parameters θ is a set of expectation values that are dependent on the classical energy function, Hamiltonian, and/or the gradient of the classical energy function. The entropy or partition function need not be directly estimated, which is an advantage of using first order information (gradients) as opposed to zeroth order information (the value of the loss itself; in this case free energy) for optimization of the QHBM ansatz.

To determine a gradient of the loss function [symbol] _{θφ} with respect to the variational parameters φ, the system computes

[symbol]

$$\begin{matrix}{∇}_{φ} {ℒ}_{VQT} ( θ , φ ) = β {∇}_{φ} F ( {\hat{ρ}}_{θ φ} ) = β {∇}_{φ} tr ( {\hat{ρ}}_{θ φ} \hat{H} ) - {∇}_{φ} S ( {\hat{ρ}}_{θ φ} ) = β {∇}_{φ} tr ( {\hat{ρ}}_{θ φ} \hat{H} ) - \text{?} = β {∇}_{φ} tr ( \hat{U} ( φ ) {\hat{ρ}}_{θ} {\hat{U}}^{†} ( φ ) \hat{H} ) , & ( 21 ) \\ \text{?} \text{indicates text missing or illegible when filed} & \end{matrix}$$

which is a gradient of an expectation value of a state with respect to a known Hamiltonian according to variations of unitary QNN parameters. Existing methods can be used to compute this quantity, e.g., analytic gradient parameter shift rule methods that allow sampling of parameter-shifted expectation values which enable unbiased estimation of the gradients. For example, in the case where the unitary QNN ansatz is a hardware-efficient ansatz, e.g., a QNN whose parameterized operations are independently parameterized and are of the form of simple exponentials of single Pauli operators e.g.

$${e}^{- \frac{i φ P}{2}} ,$$

the gradient formula becomes a difference of expectation values

$$\begin{matrix}{\partial }_{{φ}_{j}} {ℒ}_{VQT} ( θ , φ ) = β {\partial }_{{φ}_{j}} tr ( {\hat{ρ}}_{θ φ} \hat{H} ) \\ = \frac{β}{2} {∇}_{φ} tr ( \hat{U} ( φ + {Δ}^{j} ) {\hat{ρ}}_{θ} {\hat{U}}^{†} ( φ + {Δ}^{j} ) \hat{H} ) - \\ \frac{β}{2} {∇}_{φ} tr ( \hat{U} ( φ - {Δ}^{j} ) {\hat{ρ}}_{θ} {\hat{U}}^{†} ( φ - {Δ}^{j} ) \hat{H} )\end{matrix} \qquad ( 22 )$$

where

$${( {Δ}^{j} )}_{k} = \frac{π}{2} {δ}_{j k}$$

that is Δ^{j} represents a

$$\frac{π}{2}$$

magnitude shift in the j-th parameter.

Upon convergence, the system prepares the parameterized ansatz quantum state with the determined values of the first set of variational parameters and second set of variational parameters as a final approximation to the target thermal quantum state (step 506) e.g., using the parameterized mixed state model 104 of FIG. 1.

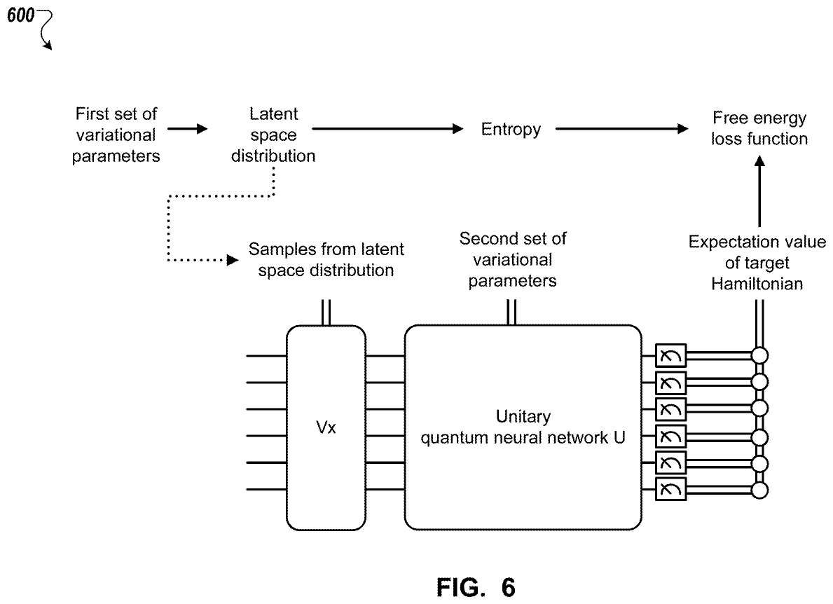

FIG. 6 is a block diagram 600 showing an example flow of information for training a parameterized mixed state model, e.g., parameterized mixed state model 104 of FIG. 1, to produce a copy of a target thermal quantum state. Dotted lines indicate classical information processing performed by a classical device and solid lines indicate operations that are stored and executed on a quantum device. The first set of variational parameters θ determine the latent space distribution. From this distribution, the entropy S(θ) is computed classically. Using samples from the latent distribution, a quantum operation is performed to prepare the state |x [symbol] [symbol] x| via the unitary Vₓ from the initial state of the quantum device. The unitary quantum neural network U is then applied and the expectation value of the target Hamiltonian is estimated at the output via several runs of classical sampling of x and measurement. The entropy and energy expectation are then combined into the free energy loss for optimization.

### Programming the Hardware: Quantum Natural Gradient Descent for Fast Convergence

When performing example process 300 or 500 above, the system can optimize the corresponding loss functions by computing gradients and updating the respective parameters via gradient descent, e.g., at iteration t loss function parameters Ω={θ, φ} can be updated as:

Ω^{(t+1)}=Ω^{(t)}−η^{(t)}∇L(Ω^{(t)}) (23)

where ∇L(Ω^{(t)})≡∇_{Ω}L(Ω)″_{Ω=Ω}_{^{(t)}} and η^{(t)} represents an iteration dependent gradient descent step size hyper parameter.

However, in some implementations the system can update the respective parameters via a quantum natural gradient descent based on a suitable metric, e.g., a Quantum Fisher Information metric, as follows.

Let Ω={θ, φ} be a concatenation of the first set of variational parameters and the second set of variational parameters. Then the second order expansion of the relative entropy of the state ρ with respect to itself at a fixed value of the parameters can be given by

R_{Ω}_{₀}(Ω)≡ [symbol] (ρ_{Ω}_{₀}∥ρ_{Ω})=½ΣⱼₖΔΩ^{j}ΔΩ^{k}gⱼₖ(Ω₀)+O(ΔΩ³), (24)

where ΔΩ≡Ω−Ω₀. The zeroth and first order terms of R_{Ω}_{₀}(Ω) are vanishing and hence non-existent, and the second order term in the Taylor expansion is effectively the Hessian matrix of R_{Ω}_{₀}(Ω) contracted with two copies of the vector representing the variation of the parameters about Ω₀. This Hessian of the relative entropy is called the Quantum Fisher Information. Therefore, the Quantum Fisher Information can be computed via the following Hessian:

gⱼₖ(Ω₀)=∂_{Ω}_{^{j}}∂_{Ω}_{^{k}}R_{Ω}_{₀}(Ω) (25)

The matrix g is called the Fisher information matrix or Fisher information metric as it can be interpreted as a metric on the parameter space geometry. It provides a notion of distance and length in parameter and provides a representation of how changes in parameter space affect changes in state space. Evaluating this metric can therefore be used to augment standard gradient descent strategies (e.g., as described above with reference to Equation (23)) to obtain natural gradient descent, as described below in Equation (26). Methods based on natural gradient descent are considered second-order methods (as they use second-order information about the landscape). Although these methods can be computationally more costly per iteration, in many cases the descent procedure can converge on a significantly smaller number of iterations to the optimal parameters.

Therefore, when performing example process 300 or 500 above, the system can optimize the corresponding loss functions by computing gradients and updating the respective parameters via

Ω^{(t+1)}=Ω^{(t)}−η^{(t)}g⁺(Ω₀)·∇L(Ω^{(t)}) (26)

where Ω₀ represents a point in parameter space and g⁺(Ω₀) represents the Moore-Penrose pseudoinverse of the matrix g(Ω₀) defined in Equation (25).

To implement the natural gradient descent update rule given in Equation (26), the system performs classical and quantum computations to calculate the matrix g(Ω₀), e.g., determine values of the matrix elements of gⱼₖ(Ω₀)=∂_{Ω}_{^{j}}∂_{Ω}_{^{k}}R_{Ω}_{₀}(Ω)=∂_{Ω}_{^{j}}∂_{Ω}_{^{k}} [symbol] (ρ_{Ω}_{₀}∥ρ_{Ω}) at each iteration.

For example, to determine matrix elements that correspond to the case where the derivatives ∂_{Ω}_{^{j}}∂_{Ω}_{^{k}} are both with respect to the first set of variational parameters θ, it can be shown that, for an input state σ,

$${\partial }_{{θ}_{j}} {\partial }_{{θ}_{k}} D ( \hat{σ} \vert \vert {\hat{ρ}}_{θ {φ}_{0}} ) = {𝔼}_{x ∼ {σ}_{{φ}_{0}} ( x )} [ {\partial }_{{θ}_{j}} {\partial }_{{θ}_{k}} {E}_{θ} ( x ) ] - {𝔼}_{y ∼ {p}_{θ} ( y )} [ {\partial }_{{θ}_{j}} {\partial }_{{θ}_{k}} {E}_{θ} ( y ) ] - {𝔼}_{y ∼ {p}_{θ} ( y )} [ ( {\partial }_{{θ}_{j}} {E}_{θ} ( y ) ) ( {\partial }_{{θ}_{k}} {E}_{θ} ( y ) ) ] - {𝔼}_{y ∼ {p}_{θ} ( y )} [ {\partial }_{{θ}_{j}} {E}_{θ} ( y ) ] \times {𝔼}_{x ∼ {p}_{θ} ( x )} [ {\partial }_{{θ}_{k}} {E}_{θ} ( x ) ] \qquad ( 27 )$$

where σ_{φ}_{₀}(x)= [symbol] x|U^{†}(φ₀)σU(φ₀)|x [symbol] . The Fisher information metric can be obtained by replacing σ with ρ_{Ω}_{₀}. in Equation (27) The first two terms cancel exactly to obtain

$${\partial }_{{θ}_{j}} {\partial }_{{θ}_{k}} D ( {\hat{ρ}}_{{θ}_{0} {φ}_{0}} \vert \vert {\hat{ρ}}_{θ {φ}_{0}} ) = - {𝔼}_{y ∼ {p}_{θ} ( y )} [ ( {\partial }_{{θ}_{j}} {E}_{θ} ( y ) ) ( {\partial }_{{θ}_{k}} {E}_{θ} ( y ) ) ] - {𝔼}_{y ∼ {p}_{θ} ( y )} [ {\partial }_{{θ}_{j}} {E}_{θ} ( y ) ] \times {𝔼}_{x ∼ {p}_{θ} ( x )} [ {\partial }_{{θ}_{k}} {E}_{θ} ( x ) ] \qquad ( 28 )$$

which is the covariance matrix of the gradient vector of the energy function subject to the sampled energy based model distribution. The system can evaluate this quantity using classical computations.

To determine matrix elements that correspond to the case where the derivatives ∂_{Ω}_{^{j}}∂_{Ω}_{^{k}} are both with respect to the second set of variational parameters φ, the system can apply a double parameter shift rule. For example, for a hardware efficient ansatz (e.g.. a QNN whose parameterized operations are independently parameterized and are of the form of simple exponentials of single Pauli operators), the parameter shift rule below can be applied

$${\partial }_{{φ}_{j}} {\partial }_{{φ}_{k}} D ( \hat{σ} \vert \vert {\hat{ρ}}_{{θ}_{0} φ} ) = \frac{1}{4} tr ( {\hat{K}}_{{θ}_{0}} {\hat{σ}}_{φ + {Δ}^{j} + {Δ}^{k}} ) + \frac{1}{4} tr ( {\hat{K}}_{{θ}_{0}} {\hat{σ}}_{φ - {Δ}^{j} - {Δ}^{k}} ) - \frac{1}{4} tr ( {\hat{K}}_{{θ}_{0}} {\hat{σ}}_{φ + {Δ}^{j} - {Δ}^{k}} ) - \frac{1}{4} tr ( {\hat{K}}_{{θ}_{0}} {\hat{σ}}_{φ - {Δ}^{j} + {Δ}^{k}} ) , \qquad ( 29 )$$

where

$${( {Δ}^{j} )}_{k} = \frac{π}{2} {δ}_{j k}$$

and σ_{φ}≡U^{†}(φ)σU(φ). This parameter shift rule includes four terms (instead of two) that depend on a parameter-shifted pulled-back data state. The system can compute the Fisher information matrix elements for this block by evaluating Equation (29) with σ=ρ_{θ}_{₀}_{φ}_{₀} using quantum computation.

To determine matrix elements that correspond to the case where the derivatives ∂_{Ω}_{^{j}}∂_{Ω}_{^{k}} are with respect to a mixture of both types of parameters θ, φ the system computes Hessian terms which are mixtures of gradients with respect to both sets of variational parameters using Equation (30) below.

$$\begin{matrix}{\partial }_{{φ}_{j}} {\partial }_{{θ}_{k}} D ( \hat{σ} \vert \vert {\hat{ρ}}_{θ φ} ) = \frac{1}{2} tr ( {\partial }_{{θ}_{k}} {\hat{K}}_{θ} {\hat{σ}}_{φ + {Δ}^{j}} ) - \frac{1}{2} tr ( {\partial }_{{θ}_{k}} {\hat{K}}_{θ} {\hat{σ}}_{φ - {Δ}^{j}} ) \\ = \frac{1}{2} {𝔼}_{x ∼ {σ}_{φ + {Δ}^{j}} ( x )} [ {\partial }_{{θ}_{k}} {E}_{θ} ( x ) ] - \\ \frac{1}{2} {𝔼}_{x ∼ {σ}_{φ - {Δ}^{j}} ( x )} [ {\partial }_{{θ}_{k}} {E}_{θ} ( x ) ] ,\end{matrix} \qquad ( 30 )$$

In Equation (30) ν_{φ}≡U^{†}(φ)σU(φ) and σ_{φ}(x)= [symbol] x|U^{†}(φ)σU(φ)|x [symbol] . The system can compute the Fisher information matrix elements for this block using a combination of the techniques described above to evaluate Equation (30) with σ=ρ_{θ}_{₀}_{φ}_{₀} via classical and quantum computation.

The above described analytic expressions for the Fisher information matrix g—which the system can compute using a mixture of quantum and classical computations—are applicable to the presently described QHBM class of models. While purely unitary QNNs may allow for the evaluation of the Fubini-Study metric (a specialization of the QFI metric to pure states), the above techniques allow for the evaluation of the Quantum Fisher Information metric exactly.

Implementations of the digital and/or quantum subject matter and the digital functional operations and quantum operations described in this specification can be implemented in digital electronic circuitry, suitable quantum circuitry or, more generally, quantum computational systems, in tangibly-embodied digital and/or quantum computer software or firmware, in digital and/or quantum computer hardware, including the structures disclosed in this specification and their structural equivalents, or in combinations of one or more of them. The term “quantum computers” or “quantum hardware” can include, but is not limited to, quantum computers, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that can be suitably approximated as a two-level system in the corresponding context. Such quantum systems can include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which can also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which can also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A digital and/or quantum computer program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that can transmit quantum data using quantum systems, e.g. qubits. Generally, a digital data communication network cannot transmit quantum data, however a quantum data communication network can transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers to be “configured to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer can receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum processors or both, or any other kind of central digital and/or quantum processing unit. Generally, a central digital and/or quantum processing unit will receive instructions and digital and/or quantum data from a read-only memory, a random access memory, or quantum systems suitable for transmitting quantum data, e.g. photons, or combinations thereof .

The essential elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more non-transitory machine-readable storage media, and that are executable on one or more digital and/or quantum processing devices. The systems described in this specification, or portions of them, can each be implemented as an apparatus, method, or system that can include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for preparing a target mixed state of a quantum system, the method comprising:
preparing a parameterized ansatz quantum state as an initial approximation to the target mixed state, wherein the parameterized ansatz quantum state comprises a first set of variational parameters and a second set of variational parameters;
determining, by classical and quantum computation, values of the first set of variational parameters and second set of variational parameters that minimize a quantum relative entropy of the target mixed state with respect to the parameterized ansatz quantum state; and
preparing the parameterized ansatz quantum state with the determined values of the first set of variational parameters and second set of variational parameters as a final approximation to the target mixed state.

2. The method of claim 1, wherein preparing the parameterized ansatz quantum state comprises applying a unitary operator to a latent quantum state, wherein the unitary operator comprises the first set of variational parameters and the latent quantum state comprises the second set of variational parameters.

3. The method of claim 2, wherein the latent quantum state is based on a parametric set of probability distributions, for example an exponential family.

4. The method of claim 3, wherein the parametric set of probability distributions are classically sampled.

5. The method of claim 2, wherein the latent quantum state comprises a parametrized latent separated mixed state.

6. The method of claim 2, wherein the latent quantum state comprises a diagonal quantum state, wherein diagonal elements of the diagonal quantum state comprise sampled values of a parametric set of probability distributions.

7. The method of claim 1, wherein determining values of the first set of variational parameters and second set of variational parameters that minimize a quantum relative entropy of the target mixed state with respect to the parameterized ansatz quantum state comprises determining values of the first set of variational parameters and second set of variational parameters that minimize a loss function based on the quantum relative entropy of the target mixed state with respect to the parameterized ansatz quantum state, wherein the loss function is given by [symbol]
_{θφ}=tr( [symbol] \hat{K}_{θφ})+log Z_{θ}
where [symbol] represents the target mixed state, \hat{K}_{θφ} represents a target Hamiltonian that is based on the first set of variational parameters and second set of variational parameters, and Z_{θ}=tr(e^{-\hat{K}}^{_{θ}}) represents a partition function with \hat{K}_{θ} representing a latent modular Hamiltonian.

8. The method of claim 7, wherein determining, by classical and quantum computation, values of the first set of variational parameters and second set of variational parameters that minimize a quantum relative entropy of the target mixed state with respect to the parameterized ansatz quantum state comprises:
setting initial values of the first set of variational parameters and the second set of variational parameters; and
iteratively determining a gradient of the loss function with respect to the first set of variational parameters and the second set of variational parameters until convergence criteria are met.

9. The method of claim 8, wherein determining a gradient of the loss function with respect to the first set of variational parameters and the second set of variational parameters comprises determining a partial derivative of the loss function with respect to the first set of variational parameters and the second set of variational parameters.

10. The method of claim 9, wherein determining the partial derivative of the loss function with respect to the second set of variational parameters comprises computing the gradient of an energy expectation of a latent modular Hamiltonian with respect to a first pulled back data state, wherein the first pulled back data state is generated by applying a quantum circuit to the target mixed state, the quantum circuit representing an inverse of a unitary operator used to prepare the parameterized ansatz quantum state.

11. The method of claim 10, wherein computing the gradient comprises computing the gradient according to a finite difference method or parameter shift gradient estimator.

12. The method of claim 9, wherein determining the partial derivative of the loss function with respect to the first set of variational parameters comprises determining a difference between i) an expected value of the gradient of an energy function with respect to a first pulled back data state, wherein the first pulled back data state is generated by applying a quantum circuit to the target mixed state, the quantum circuit representing an inverse of a unitary operator used to prepare the parameterized ansatz quantum state, and ii) an expected value of the gradient of a distribution that can be classically sampled.

13. The method of claim 12, wherein determining the partial derivative of the loss function with respect to the first set of variational parameters is independent of the partition function Z₉.

14. The method of claim 9, wherein iteratively determining a gradient of the loss function with respect to the first set of variational parameters and the second set of variational parameters until convergence criteria are met comprises, upon convergence, combining the determined partial derivatives.

15. The method of claim 1, wherein the target mixed state comprises a quantum state stored as quantum data in quantum memory.

16. An apparatus comprising:
one or more classical and quantum computers; and
one or more computer-readable media coupled to the one or more classical and quantum computers having instructions stored thereon which, when executed by the one or more computers, cause the one or more computers to perform operations comprising:
preparing a parameterized ansatz quantum state as an initial approximation to the target mixed state, wherein the parameterized ansatz quantum state comprises a first set of variational parameters and a second set of variational parameters;
determining, by classical and quantum computation, values of the first set of variational parameters and second set of variational parameters that minimize a quantum relative entropy of the target mixed state with respect to the parameterized ansatz quantum state; and
preparing the parameterized ansatz quantum state with the determined values of the first set of variational parameters and second set of variational parameters as a final approximation to the target mixed state.

17. The apparatus of claim 16, wherein the one or more classical and quantum computers comprises a parameterized mixed state model state model, wherein the parameterized mixed state model is configured to:
receive classical data representing a first set of variational parameters, wherein the first set of variational parameters define a respective variational probability distribution;
produce a latent quantum state, comprising:
sampling values from the variational distribution and defining respective unitary operators using the sampled values, wherein each unitary operator corresponds to a respective quantum circuit of quantum logic gates;
applying each unitary operator to a register of qubits in an initial quantum state to produce respective a computational basis state that correspond to a respective sampled value;
receive classical data representing a second set of variational parameters, wherein the second set of variational parameters define a parameterized unitary operator that defines a respective quantum circuit;
applying the parameterized unitary operator to the latent quantum state to obtain a model output state, wherein the model output state comprises a parameterized ansatz quantum state that depends on the first set of variational parameters and the second set of variational parameters.

18. A method for preparing a target thermal state of a quantum system, the method comprising:
preparing a parameterized ansatz quantum state as an initial approximation to the target thermal state, wherein the parameterized ansatz quantum state comprises a first set of variational parameters and a second set of variational parameters;
determining, by classical and quantum computation, values of the first set of variational parameters and second set of variational parameters that minimize a quantum relative entropy of the parameterized ansatz quantum state with respect to the target thermal state; and
preparing the parameterized ansatz quantum state with the determined values of the first set of variational parameters and second set of variational parameters as a final approximation to the target thermal state.

19. The method of claim 18, wherein preparing the parameterized ansatz quantum state comprises applying a unitary operation to a latent quantum state, wherein the unitary operation comprises the first set of variational parameters and the latent quantum state comprises the second set of variational parameters.

20. The method of claim 19, wherein the latent quantum state is based on a parametric set of probability distributions, for example an exponential family.

21. The method of claim 20, wherein the parametric set of probability distributions are classically sampled.

22. The method of claim 18, wherein the latent quantum state comprises a parametrized latent separated mixed state.

23. The method of claim 18, wherein the latent quantum state comprises a diagonal quantum state, wherein diagonal elements of the diagonal quantum state comprise sampled values of the parametric set of probability distributions.

24. The method of claim 18, wherein the target thermal state is defined by a target Hamiltonian and a target temperature.

25. The method of claim 18, wherein determining, by classical and quantum computation, values of the first set of variational parameters and second set of variational parameters that minimize a quantum relative entropy of the parameterized ansatz quantum state with respect to the target thermal state comprises:
computing, for varying values of the first set of variational parameters, multiple expectation values of the target Hamiltonian with respect to the parameterized ansatz quantum state; and
computing, for varying values of the second set of variational parameters, multiple expectation values of the target Hamiltonian with respect to the parameterized ansatz quantum state.

26. The method of claim 18, wherein determining values of the first set of variational parameters and second set of variational parameters that minimize a quantum relative entropy of the parameterized ansatz quantum state with respect to the target thermal state comprises determining values of the first set of variational parameters and second set of variational parameters that minimize a loss function based on the quantum relative entropy of the parameterized ansatz quantum state with respect to the target thermal state, wherein the loss function is given by [symbol]
_{θφ}=βtr(\hat{ρ}_{θφ}H)−S(\hat{ρ}_{θφ})
where \hat{ρ}_{θφ} represents the parameterized ansatz quantum state, H represents a target Hamiltonian that defines the target thermal state, and β represents a target temperature that defines the target thermal state.

27. The method of claim 26, wherein determining, by classical and quantum computation, values of the first set of variational parameters and second set of variational parameters that minimize a quantum relative entropy of the parameterized ansatz quantum state with respect to the target thermal state comprises:
setting initial values of the first set of variational parameters and the second set of variational parameters; and
iteratively determining a gradient of the loss function with respect to the first set of variational parameters and the second set of variational parameters until convergence criteria are met.

28. The method of claim 27, wherein determining a gradient of the loss function with respect to the first set of variational parameters and the second set of variational parameters comprises determining a partial derivative of the loss function with respect to the first set of variational parameters and the second set of variational parameters.

29. The method of claim 28, wherein determining the partial derivative of the loss function with respect to the first set of variational parameters comprises computing a set of expectation values that are dependent on a classical energy function, a pushed forward Hamiltonian and a gradient of the classical energy function, wherein the pushed forward Hamiltonian is generated by applying a quantum circuit to the target Hamiltonian, the quantum circuit representing an inverse of a unitary operator used to prepare the parameterized ansatz quantum state.

30. The method of claim 29, wherein determining the partial derivative of the loss function with respect to the first set of variational parameters is independent of an entropy or partition function.

31. The method of claim 28, wherein determining the partial derivative of the loss function with respect to the second set of variational parameters comprises computing a gradient of an expectation value of a quantum state with respect to the target Hamiltonian, wherein the quantum state is generated by applying a quantum circuit to the latent quantum state, the quantum circuit representing a unitary operator used to prepare the parameterized ansatz quantum state.

32. The method of claim 31, wherein computing the gradient comprises computing the gradient according to a finite difference method or parameter shift gradient estimator.

33. The method of claim 27, wherein iteratively determining a gradient of the loss function with respect to the first set of variational parameters and the second set of variational parameters until convergence criteria are met comprises, upon convergence, combining the determined partial derivatives.

34. The method of claim 18, further comprising determining a thermodynamic free energy of the quantum system based on determining the values of the first set of variational parameters and second set of variational parameters that minimize a quantum relative entropy of the parameterized ansatz quantum state with respect to the target thermal state.

35. An apparatus comprising:
one or more classical and quantum computers; and
one or more computer-readable media coupled to the one or more classical and quantum computers having instructions stored thereon which, when executed by the one or more computers, cause the one or more computers to perform operations comprising:
preparing a parameterized ansatz quantum state as an initial approximation to the target thermal state, wherein the parameterized ansatz quantum state comprises a first set of variational parameters and a second set of variational parameters;
determining, by classical and quantum computation, values of the first set of variational parameters and second set of variational parameters that minimize a quantum relative entropy of the parameterized ansatz quantum state with respect to the target thermal state; and
preparing the parameterized ansatz quantum state with the determined values of the first set of variational parameters and second set of variational parameters as a final approximation to the target thermal state.
